(19) United States
(12) Patent Application Publication
(10) Pub. No.: US 2015/0078361 A1
(43) Pub. Date: Mar. 19, 2015

(54) RADIO NETWORK FOR SUPPORTING FARMING OPERATIONS

(71) Applicant: Koos Technical Services, Inc., Lake Mary, FL (US)

(72) Inventors: William M. Koos, Altamonte Springs, FL (US); Larry W. Koos, Sanford, FL (US); Edward C. Gerhardt, Todd, NC (US)

(21) Appl. No.: 14/480,691

(22) Filed: Sep. 9, 2014

Related U.S. Application Data
(60) Provisional application No. 61/877,675, filed on Sep. 13, 2013.

(51) Int. Cl. H04L 12/28; H04W 76/02

(52) U.S. Cl. CPC H04L 12/2818; H04W 76/02; H04L 12/282
USPC 370/338

(57) ABSTRACT

A farm irrigation network includes an irrigation assembly having a radio, a soil moisture sensor assembly having a radio, and a sub-master site having a first radio and a second radio. The first radio and the radios of the irrigation assembly and the soil moisture assembly form a local network and the second radio is configured to communicate with a backhaul medium to establish communications with a server.

### RELATED APPLICATION DATA

This application claims the benefit of U.S. Provisional Patent Application No. 61/877,675, filed Sep. 13, 2013, the disclosure of which is incorporated herein by reference in its entirety.

### TECHNICAL FIELD OF THE INVENTION

The technology of the present disclosure relates generally to wireless communications and, more particularly, to a radio network topology that may be implemented to support distributed operations such as farming operations.

### BACKGROUND

Control over farming operations and other operations is often difficult due to the large distances involved and lack of infrastructure, such as communication lines and electric lines.

### SUMMARY

Disclosed is a wireless farm irrigation network (FIN) designed to provide farmers with information and control capabilities to assist in optimizing the irrigation of crops.

The FIM provides one or more of the following advantages of conventional farming operations:
Automatic, wireless collection of soil moisture level readings over a wide area.
Moisture level readings at multiple soil depths.
Measurement of water volume pumped during irrigation.
Remote monitoring and control of irrigation pumps.
Communications link to vehicles (e.g., tractors) operating in the field.
Open architecture for sensors.
Open architecture for data collection and access.
Solar and/or battery powered equipment.
Upgradable hardware equipment and/or upgradable software to provide additional services.
Access to information at any time using a web-browser or via message-based communications (e.g., email, text messaging, multimedia messaging).
Automatic notification of low moisture levels.
Automatic pump turn-off when user-specified moisture levels are reached during watering.

### BRIEF DESCRIPTION OF THE DRAWINGS

FIG. 1 is a schematic block diagram of a representative topology for a farm irrigation network (FIN).

FIG. 2 is a schematic block diagram of components of a representative FIN located at a representative farm.

FIG. 3 is another schematic block diagram of a representative topology for a FIN.

FIG. 4 is a schematic block diagram of a representative sensor assembly component of the FIN.

FIG. 5 is a schematic block diagram of a representative sub-master component of the FIN.

### DETAILED DESCRIPTION OF EMBODIMENTS

### 1. Introduction

Embodiments will now be described with reference to the drawings, wherein like reference numerals are used to refer to like elements throughout. It will be understood that the figures are not necessarily to scale. Features that are described and/or illustrated with respect to one embodiment may be used in the same way or in a similar way in one or more other embodiments and/or in combination with or instead of the features of the other embodiments.

2. Overview

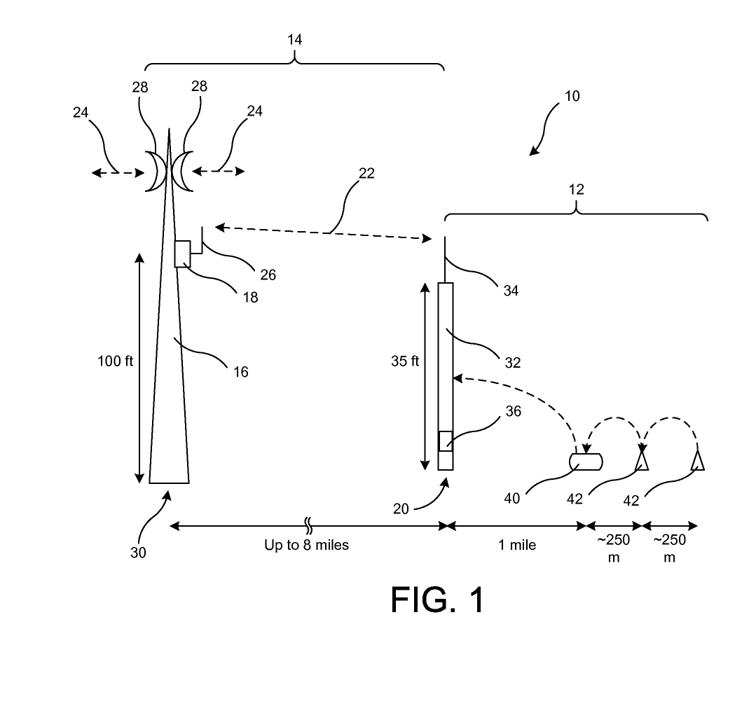

With initial reference to FIG. 1, a farm irrigation network (FIN) 10 includes backhaul communications and local communications conducted over a local network 12. The backhaul communications may be implemented using different types of backhaul topologies. In one embodiment, where existing or planned real time kinematic (RTK) tower infrastructure is present and available as a platform to install or otherwise support a wireless backhaul network, the FIN may include a wireless backhaul network 14 using the RTK tower infrastructure. In one embodiment, the wireless backhaul network 14 is embodied as a white space backhaul network, but other wireless platforms may be used for the wireless backhaul network 14.

A white space network is a network that operates on one or more unoccupied channels that are interleaved with channels used by incumbent or licensed users. For instance, unused television channels may be used for wireless communications by devices (referred to as white space devices or WSDs) that register for a channel list of available channels that are not occupied by incumbent users. Exemplary incumbent users in this context are broadcast television stations. Typically, WSDs must tolerate use of available channels by other WSDs in similar manner to the sharing of unlicensed spectrum.

The wireless backhaul network 14 provides a connection from a network of equipment at the farm (e.g., the local network 12, discussed below) to a support server (not shown) via the Internet. The server processes information from the equipment at the farm and may issue control commands to equipment at the farm.

If an available RTK tower infrastructure is not within operative range of the farm, then a different backhaul approach may be used. For instance, the FIN may use a cellular network to provide Internet access to establish operative communications from a single site on the farm to the server.

Using the wireless backhaul network 14, sensor data that is automatically collected by sensors at the farm or collected in response to a user request is communicated to server. The automatic collection of data may occur at user specified times, such as 2 or 3 times per day. The server provides a secure interface and hosts an Internet-style website for the user to view and evaluate the information at any time using a computer or other electronic device (e.g., a tablet or a smartphone) that has an Internet connection. Through the website, the user also may be able to control irrigation (e.g., turning on and off pumps and/or control water flow control valves). The control over irrigation may be manual and/or automated based on user-defined watering metrics that employ moisture sensing data as feedback information from the farm to start or stop watering. For this purpose, moisture level sensing may occur between watering events and, in some embodiments, during watering.

The server also may be configured to send data, such as summaries of irrigation information or soil conditions, to the user's electronic device by email, text message or multimedia message. These messages may be sent on a predetermined basis (e.g., daily) and/or when soil moisture levels cross a predetermined threshold (e.g., a predetermined low level indicating dry soil or a predetermined high level indicating wet soil). The predetermined thresholds may be established by the user. The messages may contain moisture readings for one or more moisture sensing assemblies and/or alerts of moisture conditions. The server may also send water usage reports and/or make water usage metrics available through the website.

As a result, farmers (with the appropriate login and/or password credentials) may connect to the server at any time to assess information about conditions at the farm and control watering on the farm. As will be appreciated, a wide variety of control parameters may be set, such as a maximum time for an irrigation pump to run, or a moisture level reading from a moisture probe may trigger the commencement and/or stoppage of watering from irrigation equipment that corresponds to the moisture probe that generated the reading. Also, control over the amount of water delivered to crops may be controlled, such as control over the total volume of water and/or the rate of watering.

### 3. Network Topology

In some areas, control over the movement of tractors, trucks and combines is aided by the uses of RTK enhanced GPS location measures. RTK employs fixed towers with RTK radio equipment. RTK towers are typically 100 to 175 feet tall and are used to transmit the RTK signals to receiver units on the farm vehicles. In these locations, towers are in place that may support the FIN 10 disclosed in this document.

With continued reference to FIG. 1, schematically illustrated are the components of the FIN 10 when using one or more RTK towers 16 to support a backhaul portion of the FIN 14. In one embodiment, a master site radio assembly 18 is installed at each of one or more of the RTK towers 16 in a service area of the FIN 14. The master site radio assembly 18 may include one or more radios (e.g., modems) and at least one antenna for each radio. The master site radio assembly 18 establishes communication with a radio assembly of a sub-master 20 at the farm over a first communication link 22. The master side radio assembly 18 also establishes backhaul communications with other nodes, such as one or more other master side radio assemblies 18 correspondingly located on nearby RTK towers 16. Communications with other backhaul nodes (e.g., the other master side radio assemblies 18) are made over one or more second communication links 24.

In one embodiment, the master side radio assembly 18 includes a WSD for establishing the first communication link 22. In other embodiments, and as explained in greater detail below, the radio assembly 18 includes a cellular modem for establishing the first communication link. In the white space embodiment, the first communication link 22 may be a white space radio link operating on an available TV white space channel in the 470 to 698 MHz range. An exemplary WSD suitable for this purpose is an Agility® White Space Radio (AWR) available from KTS Wireless of Lake Mary, Fla. To support the first communication link 22, the master side radio assembly 18 may include an omnidirectional antenna 26 associated with the WSD. The antenna 26 is installed on an appropriate RTK tower 16 in a service area of the FIN 14. As will be discussed in more detail, the WSD at the RTK tower 16 communicates with WSD radio equipment installed at the sub-master 20 that is at the farm level.

To establish backhaul communications over the second communications link(s) 24, the master side radio assembly 18 may use the WSD that establishes the first communication link and/or one or more additional WSDs at each respective RTK tower 16. In this manner, the master side radio assemblies 18 may form the wireless backhaul network 14 by communicating with one another to relay data to a node that is operatively connected to the Internet. Each WSD in the system may register for and use white space channels for its wireless communications. The registration may be made with a white space channel allocation system (sometime referred to as a white space database or registration system) via the Internet.

In another embodiment, other types of backhaul radios may be installed at the RTK towers 16 and used to establish the second communication links 24. In this manner, data may be relayed via the second communication links 24 and master side radio assemblies 18 to a node that is operatively connected to the Internet. For instance, two or more unlicensed radios operating at 5.8 GHz may be installed at each RTK tower 16 in the service area. A directional antenna 28 for each backhaul radio of this type is also installed on the RTK tower 16. Using the backhaul radio and associated antenna, the master side radio assembly 18 may communicate with another master side radio assembly 18 located on an adjacent or nearby tower or other location. It is noted, however, that end nodes need not have more than one backhaul radio and antenna pair of this type.

Each antenna mounted to the RTK tower 16 (e.g., the two directional antennas 28 and the one omnidirectional antenna 26 in the embodiment illustrated in FIG. 1) is installed at an appropriate height. For instance, in the U.S., the governing regulatory agency (i.e., the Federal Communications Commission or FCC) limits the height of antennas for WSDs to 100 feet. To maximize performance of the WSDs in the FIN, the omnidirectional antennas 26 may be placed at the regulatory height limit. Other heights may be used if circumstances allow or limit the installation height. The directional antennas 28 may be mounted at the same height or another height.

Each tower site with FIN equipment may be referred to as a master site 30. Each farm or, for large farms each portion of a farm, includes a sub-master site 20 that communication with a nearby master site 30. Each master site 30 provides a coverage area around the respective RTK tower 16 and communicates directly with one or more sub-master sites 20 that are in the coverage area with a first communication link 22. In the embodiment where WSDs are employed to establish the first communication links 22, the coverage area for each master site 30 may typically extend out about 8 miles from the respective RTK tower 16 (e.g., the coverage area is generally circular and has a radius of about 8 miles in this embodiment).

Within the coverage area of a master site 30, plural sub-master sites 20 may be present. Typically, one sub-master site 20 in accordance with the embodiment described below will cover about 1,200 acres. Changes to the configuration of the master site 30, the sub-master site 20, or both may be made to accommodate a specific implementation of the FIN 10 and these changes may alter these coverage areas.

Each sub-master site 20 may include a tower 32, such as a 40 foot tower. The tower 32 of the sub-master site 20 may support an antenna 34. An exemplary antenna 34 for the sub-master site 20 is a directional, yagi antenna mounted about 35 feet above the ground. Located at the sub-master site 20 is a radio assembly 36, such as a WSD configured to communicate with the master site 30 over an appropriate white space channel and first communication link 22 via the yagi antenna 34 and the omnidirectional antenna 26. Thus, the radio assembly 36 (e.g., WSD at the sub-master site 20) may be considered to be configured as a remote and provides a communication link for measurement data obtained at the farm to be communicated to the master site 30. As indicated and as will be described in greater detail below, the sub-master site may alternatively communicate with appropriate devices (e.g., an Internet-based server) using a cellular modem and communication link.

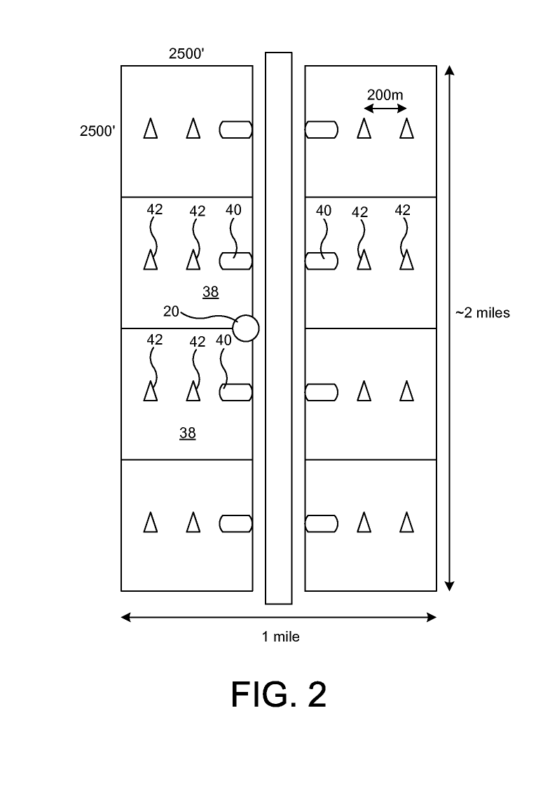

FIG. 2 illustrates a representative arrangement of FIN components serviced by a sub-master site 20 at the farm level. The sub-master site 20 could, for example, be installed near the center or other appropriate of a farm. In one embodiment, depending on the geographical arrangement of the farm or section thereof, a sub-master site 20 deployed in accordance with the described embodiments may service a 1,200 acre area. In the exemplary arrangement of FIG. 2, the service area of the sub-master site 20 is divided into eight sections 38 (also referred to as plots) of about 150 acres each. The illustrated example shows eight sections 38 arranged in a two by four matrix with a service road separating the sections. It will be appreciated that other arrangements are possible and that the sub-master site 20 may service more than or less than eight sections.

Each section 38 of the service area of the sub-master site 20 has a respective irrigation source 40. A typical irrigation source 40 includes a well and a pump, although others types of sources are possible. An outside source of electricity (e.g., from a commercial power company) is typically available at the irrigation source, but this need not be the case. For example, the pump may be powered by a gas or diesel engine. In some instances, mechanical power from this engine may be used to generate electrical power. In the absence of an outside source of electricity or locally generated electricity, radios and electronics at the irrigation source may be powered with batteries and/or a solar panel. Typically, a flow meter will be present at the irrigation source to provide a measure of the volume of water used over a period of time. Also, the irrigation source includes an on/off control mechanism, such as a relay that controls whether a pump is on or off.

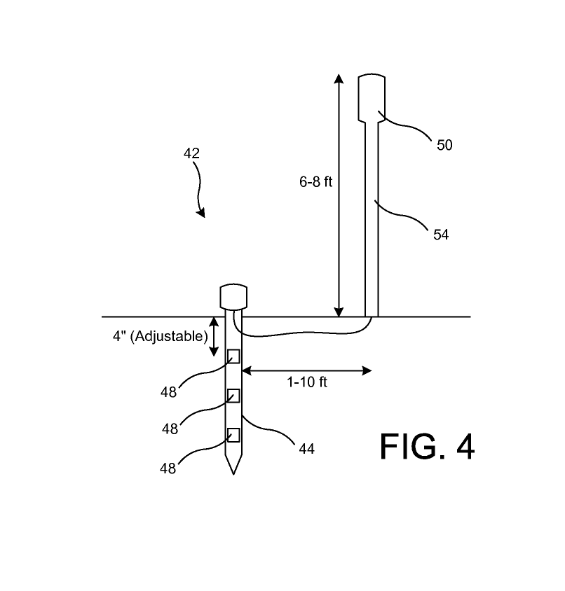

With additional reference to FIG. 4, deployed in each section 38 are also one or more moisture sensor assemblies 42. Each moisture sensor assembly 42 typically includes a probe 44 that is inserted into the ground 46. Each probe 44 includes one or more sensors 48 that are configured to take moisture level readings. In an exemplary embodiment, the moisture sensor assemblies 42 have more than one sensor 48 (e.g., two or three sensors along the probe or, in another embodiment, two to twelve sensors along the probe) to take respective readings at different depths into the ground. The sensors 48 may be standard, commercially available sensors that provide electronic output of moisture readings.

In the example shown, one irrigation source 40 and two soil moisture sensor assemblies 42 are present in each section 38 of the service area of the sub-master site 20. It will be appreciated that more than one irrigation source 40 may be present in a section 38 and/or more than or less than two soil moisture sensor assemblies 42 may be present in a section 38.

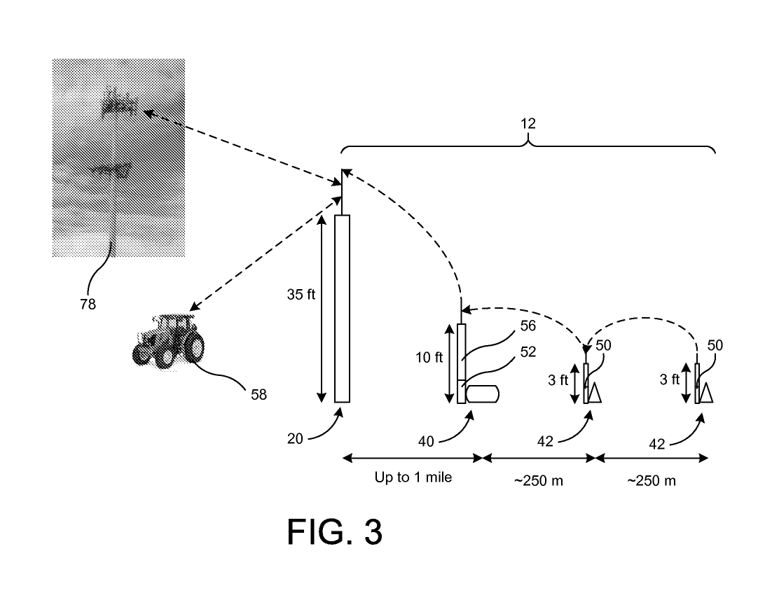

With additional reference to FIG. 3, the sub-master site 20, which may be located near a collective center of the sections 38 serviced by the sub-master site 20, communicates with various wireless devices in each section 38. For drawing simplification, the FIN 10 components of one section 38 are shown in FIG. 3. The wireless devices in a section 38 include a radio 50 and corresponding antenna at each moisture sensor assembly 42 and a radio 52 and corresponding antenna at each irrigation source 40. The radios 50 at the moisture sensor assemblies 42 transmit moisture readings to the sub-master site 20. Again referring to FIG. 4, the radios 50 may be mounted to a mast 54 located near the corresponding probe 44. The mast 54 may be made from a PVC pipe or pole and include an enclosure for the radio 50. The radios 52 at the irrigation sources 40 transmit data regarding the respective irrigation source 40 (e.g., one or more of water flow rate, water pressure, water consumption, equipment fault conditions, etc.) to the sub-master site 20. Similar to the radios 50 at the moisture sensor assemblies 42, the radios 52 at the irrigation sources 40 may be mounted to a mast 56 (FIG. 3) located near the corresponding irrigation source 40. Also, commands to control irrigation may be transmitted from a controlling device (e.g., the above-mentioned server or user device) via the master site 30 to the sub-master site 20 and then to the radio 52 at the proper irrigation source 40. The radio 52 at the irrigation source 40 is coupled to appropriate irrigation control equipment that effectuates the commands. The commands will be adapted for the equipment at the irrigation site 40. Exemplary commands include, but are not limited to, relay control commands to turn on or off a pump or a generator, commands to control the speed of a pump, commands to open, close or adjust a valve or flow regulator, and so on.

To extend the wireless communication range of radios 50, 52 in the sections 38, transmissions may not be directly between each radio 50, 52 and the sub-master site 20. Rather, transmissions from a radio 50 at one moisture sensor assembly 42 may be relayed through another radio 50 at another moisture sensor assembly 42 and/or a radio 52 at an irrigation source 40. Also, depending on the configuration at a particular farm, communications between a radio 52 at an irrigation source 40 and the sub-master site 20 may be relayed through a radio 50 at another irrigation source 40 and/or a radio 50 at a moisture sensor assembly 42. In one embodiment, the radios 36, 50, 52 at the sub-master site 20, the moisture sensor assemblies 42, and the irrigation sources 40 wirelessly communicate using unlicensed spectrum, such as spectrum in the 902 MHz to 928 MHz bands under a standard communication protocol, a mesh protocol, or a peer-to-peer protocol. For instance, the communications may take place at around 900 MHz under IEEE 802.15.4 in a mesh topology.

FIG. 3 illustrates exemplary communication pathways within the local network 12 of the FIN 10 and from the local network 12 to other equipment, such as the illustrated tractor 58. In one embodiment, the sub-master site 20 also may communicate with equipment in addition to the irrigation sources 40 and the moisture sensor assemblies 42. For example, the sub-master site 20 may provide Internet access for a computer used by the farmer to access the server to review data collected from the irrigation sources 40 and/or the moisture sensor assemblies 42 and to control the watering of crops. The other equipment also may include other types of sensors, such as thermometers, humidity sensors, barometers, light sensors to determine sunlight intensity, rainfall sensors, and other sensors used to detect conditions at the farm. Data from these sensors may be further used to control watering operations. As another example, communications may be established with farm equipment (e.g., the illustrated tractor 58, harvesters, trucks, etc.) to coordinate operations or provide other wireless communication services. The serviceable range from the sub-master site 20 to other equipment in the embodiment implemented with unlicensed spectrum in the 902 MHz to 928 MHz bands is about one mile. The wireless communications between the sub-master site 20 and other equipment may be over these bands or other bands, such as over white space channels.

FIG. 4 shows a typical moisture sensor assembly 42 with multiple soil moisture sensors 48. The moisture sensor assembly 42 includes standard sensors with a serial interface (e.g., an SDI-12 interface) or an open architecture interface over which the sensors report moisture content in direct units (e.g., a ratio of cubic millimeters (mm3) of water to cubic millimeters of soil). In the illustrated embodiment, near the moisture sensor assembly 42 is a pole 54 that supports the radio 50 (e.g., a 900 MHz radio) and/or associated antenna. The radio 50, or an interface device, converts the readings from each of the sensors 48 on the probe 44 to a wireless message that is sent to the sub-master site 20. In one embodiment, a standard mesh communication protocol is included to allow a radio 50 at a soil moisture sensor assembly 40 closer to the sub-master site 20 to act as a repeater for radios 50 at soil moisture sensor assemblies 42 further from the sub-master site 20.

A battery (not shown) at each soil moisture sensor assembly 42 may power the sensors 48, radio 50 and any other electronics at the soil moisture sensor assembly 42. Alternatively, or in addition to a battery, a solar power source may be present to power the devices and/or charge the battery. In one embodiment, these devices are powered only during data collection and transmission to conserve power. In one embodiment, the battery is sized to power one year of normal operation, including two to three moisture readings per day per sensor during a 6-month growing season.

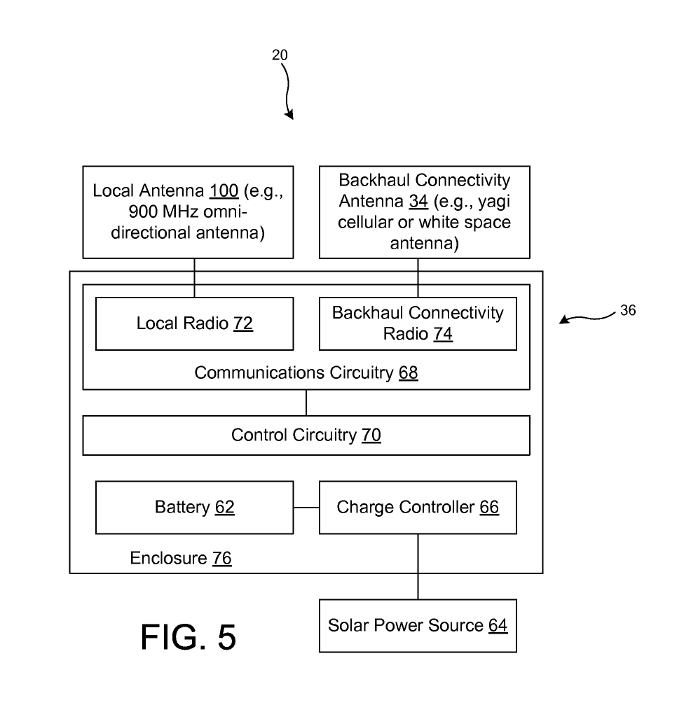

FIG. 5 illustrates exemplary components of the sub-master site 20. These components may include a backhaul connectivity antenna 34, such as white space yagi antenna (operating at, for example, 470-698 MHz), for communications with the master site 30 and a local antenna 60, such as a 900 MHz omnidirectional antenna, for communicating with the radios 50, 52 at the irrigation sources 40 and moisture sensor assemblies 42. A battery 62 (e.g., a lead-acid battery) and solar battery charger, such as a solar power source 64 (e.g., solar panel) and charge controller 66, may provide power (e.g., 12 VDC) to the radio equipment 68 (e.g., WSD and 900 MHz radio) and any other electronics (e.g., control circuitry 70) at the sub-master site 20. As indicated, the radio equipment may include a local radio 72 for establishing communication with the radios 50, 52 and a backhaul connectivity radio 74 for establishing communication with the master site 30. Components of the radio assembly 36 may be housed in an enclosure 76 to protect the components from the elements.

The radios in the FIN 10 each may include functionality to carry out the described operations. Therefore, the radios 18, 36, 50, 52 may include processing capabilities to carry out programmed actions and, if appropriate, store data. For these purposes, the radios 18, 36, 50, 52 may include control circuits (e.g., the control circuitry 70 of radio assembly 36) having processors or other logic elements to execute logical instructions and may include memories. Alternatively, electronic devices (e.g., interface devices, simple computing devices, etc.) that carry out various functions may be present in conjunction with one or more of the radios 18, 36, 50, 52. In addition, the server may be a typical computer server that hosts website functionality. Such servers include a processor for executing logical instructions and a memory to store data and executable programs.

With reference to the embodiment depicted in FIG. 3 and the sub-master site depicted in FIG. 5, there may be areas where no RTK network is available, but cellular network coverage is present. In this case, FIN sub-master site 20 may include a standard cellular modem as the backhaul connectivity radio 74. In this case, the cellular modem, via an appropriate backhaul connectivity antenna 34, communicates with a cellular network (represented by tower 78) to gain Internet access. In this embodiment, master sites 30 may be omitted. Data is collected at the sub-master site 20 as in the prior embodiment using the local network 12 (e.g., a 900 MHz mesh network) and communicated to the server over the Internet using the single cellular modem and cellular network. While there may be service fees for cellular network access, there is still a cost savings compared to placing a cellular modem at each irrigation source and/or at each soil moisture sensor assembly. In some instances, such as when there is an outlying irrigation source 40 or moisture sensor assembly 42, one or more of the radios 50, 52 may be a cellular radio or other radio (e.g., a WSD to communicate with a master site 30). In this case, a hybrid system of a local network 12 plus some use of backhaul access in addition to the sub-master site 20 may be employed.

The local communication network 12 at the farm level (e.g., among the sub-master site 20, the radios 52 at the irrigation sources 40, and the radios 50 at the soil moisture sensor assemblies 42) may be implemented in the same manner as described above. Therefore, the differences in the disclosed exemplary topologies of the sub-master sites 20 are that, in the cellular backhaul embodiment, a cellular modem replaces the WSD and the yagi antenna supports cellular carrier frequency bands instead of white space bands (e.g., TV white space bands in the 470-698 MHz range). Of course, other differences may be present and/or another type of wired or wireless connection to a backhaul network or the Internet may be made.

In either backhaul connectivity embodiment (e.g., the cellular network embodiment or the RTK tower embodiment), if a farm is large enough so that multiple sub-master sites 20 are used to provide adequate coverage area for the irrigation sources 40 and moisture sensor assemblies 42, then a network (e.g., a white space network) may be established among the sub-master sites 20. The data for the entire farm may be concentrated at one sub-mater site 20 and communicated to the server via the Internet where Internet access at the sub-master site 20 is via a single cellular modem or an operative communication link to a WSD on an RTK tower.

### 4. Conclusion

Although certain embodiments have been shown and described, it is understood that equivalents and modifications falling within the scope of the appended claims will occur to others who are skilled in the art upon the reading and understanding of this specification.

What is claimed is:

1. A farm irrigation network, comprising:
an irrigation assembly comprising a radio;
a soil moisture sensor assembly comprising a radio;
a sub-master site comprising a first radio and a second radio, the first radio and the radios of the irrigation assembly and the soil moisture assembly forming a local network and the second radio configured to communicate with a backhaul medium to establish communications with a server.
